(19) United States
(12) Patent Application Publication
(10) Pub. No.: US 2026/0016581 A1
(43) Pub. Date: Jan. 15, 2026

(54) LIDAR, CALIBRATION METHOD THEREFOR, CALIBRATION APPARATUS THEREFOR, AND STORAGE MEDIUM

(71) Applicant: HESAI TECHNOLOGY CO., LTD., Shanghai (CN)

(72) Inventors: Feng LIANG, Shanghai (CN); Shaoqing XIANG, Shanghai (CN)

(73) Assignee: HESAI TECHNOLOGY CO., LTD., Shanghai (CN)

(21) Appl. No.: 19/338,416

(22) Filed: Sep. 24, 2025

Related U.S. Application Data
(63) Continuation of application No. PCT/CN2024/083540, filed on Mar. 25, 2024.

(30) Foreign Application Priority Data
Mar. 24, 2023 (CN) 202310301496.5

(51) Int. Cl. G01S 7/497; G01S 7/4861; G01S 7/487; G01S 17/10; G01S 17/86

(52) U.S. Cl. CPC G01S 7/497; G01S 7/4861; G01S 7/4873; G01S 17/10; G01S 17/86

(57) ABSTRACT

This disclosure provides a LiDAR, a calibration method, a calibration apparatus, and a storage medium. The LiDAR includes a light emitter, a light receiver, an ambient-light detector, an echo detector and a processor. The light emitter is configured to emit a detection pulse signal for detecting an object. The light receiver is configured to receive an ambient light and generate a first output signal, and to receive an echo and generate a second output signal. The ambient-light detector is configured to generate an ambient light signal based on the first output signal from the light receiver. The echo detector is configured to generate an echo signal based on the second output signal from the light receiver. The processor is coupled to the ambient-light detector and the echo detector. The processor is configured to determine a distance to an object based on the ambient light signal and the echo signal.

### CROSS-REFERENCE TO RELATED APPLICATION(S)

This application is a continuation application of copending International Patent Application No. PCT/CN2024/083540, filed on Mar. 25, 2024, which claims priority to Chinese Patent Application 202310301496.5, filed on Mar. 24, 2023, the content of which is incorporated herein by reference in its entirety.

### TECHNICAL FIELD

This disclosure relates to the field of light detection and ranging (“LiDAR”), and particularly relates to a LiDAR, a calibration method for a LiDAR, a calibration apparatus for a LiDAR, and a storage medium.

### BACKGROUND

A LIDAR is an important sensor for autonomous driving. A LIDAR includes components, such as a light emitter, a light receiver, or the like. The light receiver includes a single photon detector, which can be a silicon photomultiplier (“SiPM”), a single photon avalanche diode (“SPAD”) array, or the like.

However, the above-mentioned single photon detector has a high sensitivity and can detect a single photon, while ambient light exists around the LiDAR and cause interferences in an echo signal generated by the single photon detector, so that the acquired detection results can be inaccurate.

There is little or no technical solution that can effectively solve the problem that the detection results acquired by the LiDAR are inaccurate due to an effect on an echo signal of the single photon detector caused by ambient light.

### SUMMARY

In this disclosure, an echo signal is corrected by measuring an ambient light signal, to reduce or eliminate the impact of ambient light on the echo signal, and improve the accuracy of the target object detection result using a LiDAR.

In a first aspect, an embodiment of this disclosure provides a calibration method for a LiDAR. The LiDAR includes a light receiver, an ambient-light detector configured to detect ambient light, and an echo detector configured to detect an echo from a target object. The light receiver is coupled to the ambient-light detector and the echo detector. Based on an output signal from the light receiver, the ambient-light detector generates an ambient light signal, and the echo detector generates an echo signal. The calibration method includes: determining the ambient light signal and the echo signal; correcting an echo signal parameter based on the ambient light signal, the echo signal parameter being configured to be obtained based on the echo signal; and determining a target object detection result based on the corrected echo signal parameter.

Optionally, the echo signal parameter includes at least one of: a waveform, a peak value, a slope, and a pulse width of the echo signal.

Optionally, correcting the waveform of the echo signal based on the ambient light signal to obtain a target echo signal. The target echo signal is configured to obtain the target object detection result.

Optionally, correcting at least one of the peak value, the slope, and the pulse width to obtain at least one of a target peak value, a target slope, and a target pulse width. The target peak value, the target slope, and the target pulse width are configured to obtain the target object detection result.

Optionally, the slope includes a leading-edge slope configured as a slope between at least two echo signal values obtained at a rising edge of the echo signal based on an echo detection threshold.

Optionally, the larger the ambient light signal is, the larger a calibration value of the correction for the echo signal parameter is.

Optionally, the light receiver includes a single photon detector. The calibration value includes a first calibration value. The first calibration value is configured to correct a gain variation amount of the single photon detector.

Optionally, determining the first calibration value based on the ambient light signal and a first calibration value coefficient, where the larger the first calibration value coefficient is, the larger the first calibration value is; and correcting the echo signal parameter using the first calibration value.

Optionally, the correcting the echo signal parameter using the first calibration value includes: determining a distance to the target object based on the echo signal parameter corrected using the first calibration value.

Optionally, the first calibration coefficient is obtained by: determining a first test echo signal parameter when the ambient light signal is greater than a light intensity threshold, and a standard echo signal parameter corresponding to the ambient light signal; and obtaining the first calibration coefficient by fitting the ambient light signal, the first test echo signal parameter, and the standard echo signal parameter.

Optionally, the calibration value further includes a second calibration value. The second calibration value is configured to correct a variation amount of a photon detection efficiency of the single photon detector.

Optionally, determining the second calibration value based on the ambient light signal and a second calibration coefficient, where the larger the second calibration coefficient is, the larger the second calibration value is; and correct the echo signal parameter using the second calibration value.

Optionally, determining a reflectivity of the target object based on the echo signal parameter corrected using the first calibration value and the second calibration value.

Optionally, the second calibration coefficient is obtained by: determining a second test echo signal parameter when the ambient light signal is less than a light intensity threshold, and a standard echo signal parameter corresponding to the ambient light signal; and obtaining the second calibration coefficient by fitting the ambient light signal, the second test echo signal parameter, and the standard echo signal parameter.

Optionally, determining the ambient light signal and the echo signal within a target detection period. The target detection period is configured to detect the target object using the LiDAR.

In a second aspect, this disclosure further discloses a calibration apparatus for a LiDAR. The LiDAR includes a light receiver, an ambient-light detector configured to detect ambient light, and an echo detector configured to detect an echo from a target object. The light receiver is coupled to the ambient-light detector and the echo detector. The ambient-light detector generates an ambient light signal and the echo detector generates an echo signal based on an output signal from the light receiver. The calibration apparatus for detecting ambient light includes: an determiner configured to determine the ambient light signal and the echo signal; a corrector configured to correct an echo signal parameter based on the ambient light signal, the echo signal parameter being configured to be obtained based on the echo signal; and a computer configured to determine a target object detection result based on the corrected echo signal parameter.

Optionally, the echo signal parameter includes a waveform of the echo signal. The corrector includes: a first correcting unit configured to correct the waveform of the echo signal based on the ambient light signal to obtain a target echo signal. The target echo signal is configured to acquire the target object detection result.

Optionally, the echo signal parameter includes a peak value, a slope, and a pulse width. The corrector includes: a second correcting unit configured to correct at least one of the peak value, the slope, and the pulse width to obtain at least one of a target peak value, a target slope, and a target pulse width. The target peak value, the target slope, and/or the target pulse width are configured to acquire the target object detection result.

In a third aspect, this disclosure further discloses a computer-readable storage medium storing a computer program thereon. The computer program, when run by a computer, executes steps of the calibration method for a LiDAR.

In a fourth aspect, this disclosure further discloses a LiDAR. The LiDAR includes: a light emitter configured to emit a detection pulse signal for detecting a target object; a light receiver configured to receive a light signal and generate an output signal, the light signal including ambient light and an echo of the detection pulse signal reflected from the target object; an ambient-light detector configured to generate an ambient light signal based on the output signal from the light receiver; an echo detector configured to generate an echo signal based on the output signal from the light receiver; and a memory and a processor. The memory stores a computer program runnable on the processor. The processor, when running the computer program, executes steps of the calibration method for a LiDAR of any of claims 1 to 15.

Optionally, the ambient-light detector includes: an integrator configured to integrate a direct current (“DC”) component of the output signal generated by the light receiver after receiving the light signal; and a first sampling module configured to sample an output signal from the integrator to obtain the ambient light signal.

Optionally, the echo detector includes: an amplifier configured to amplify an alternating current (“AC”) component of the output signal generated by the light receiver after receiving the light signal; and a second sampling module configured to sample an output signal from the amplifier to obtain a waveform of the echo signal.

Optionally, the echo detector includes: an amplifier configured to amplify an AC component of the output signal generated by the light receiver after receiving the light signal to obtain the echo signal; a first comparator configured to compare the echo signal with a first threshold and output a first comparison result, the first threshold being configured to be used when the ambient light signal reaches a light intensity threshold; a third sampling module configured to sample the first comparison result to obtain the echo signal parameter; a second comparator configured to compare the echo signal with a second threshold and output a second comparison result, the second threshold being configured to be used when the ambient light signal is less than the light intensity threshold; and a fourth sampling module configured to sample the second comparison result to obtain the echo signal parameter. The echo signal parameter includes at least one of: a peak value, a slope, and a pulse width of the echo signal.

Technical solutions of embodiments of this disclosure have the following beneficial effects.

In this disclosure, the ambient light signal and the echo signal are acquired, the echo signal parameter is corrected based on the ambient light signal, the echo signal parameter is configured to be obtained based on the echo signal; and the target object detection result is determined based on the corrected echo signal parameter. In this disclosure, the echo signal parameter is corrected using the acquired ambient light signal, to reduce or eliminate the impact of the ambient light on the echo signal, so that the corrected echo signal parameter can accurately reflect the real condition of the target object, thereby improving the accuracy of the target object detection result and the detection performance of the LiDAR.

Further, the waveform of the echo signal is corrected based on the ambient light signal to obtain a target echo signal. The target echo signal is configured to obtain the target object detection result. Since the ambient light can affect the waveform of the echo signal, causing change of the waveform of the echo signal, the waveform of the echo signal is corrected in this disclosure to reduce or eliminate the impact of the ambient light on the waveform of the echo signal, so that the target echo signal can accurately reflect the real condition of the target object (e.g., distance and/or reflectivity), thereby improving the accuracy of target object detection.

Further, at least one of the peak value, the slope, and the pulse width of the echo signal is corrected based on the ambient light signal, to obtain at least one of the target peak value, the target slope, and the target pulse width. The target peak value, the target slope, and the target pulse width are can obtain the target object detection result. Since the ambient light can affect the peak value, the slope, and the pulse width of the echo signal, the above parameters can be corrected in this disclosure to reduce the impact of the ambient light on the peak value, the slope, and the pulse width of the echo signal, and obtain the target parameters, thereby improving the accuracy of target object detection.

Further, the calibration includes a first calibration value. The first calibration value is can correct a gain variation amount of the single photon detector. In this disclosure, the gain variation amount of the single photon detector is corrected using the first calibration value, to reduce or eliminate the impact of the ambient light on the gain of the single photon detector, thereby improving the accuracy of target object detection.

Further, the calibration further includes a second calibration value. The second calibration value is can correct a variation amount of a photon detection efficiency of the single photon detector. In this disclosure, the photon detection efficiency of the single photon detector is corrected using the second calibration value, to reduce or eliminate the impact of the ambient light on the photon detection efficiency of the single photon detector, thereby improving the accuracy of target object detection.

### BRIEF DESCRIPTION OF DRAWINGS

FIG. 1 shows a schematic structural diagram of an example receiving terminal circuit of a LiDAR, consistent with some embodiments of this disclosure.

FIG. 2 shows a flowchart of an example calibration method for a LiDAR, consistent with some embodiments of this disclosure.

FIG. 3 shows a schematic diagram of an example structure of a receiving terminal circuit of a LiDAR, consistent with some embodiments of this disclosure.

FIG. 4 shows a schematic diagram of an example structure of a receiving terminal circuit of another LiDAR, consistent with some embodiments of this disclosure.

FIG. 5 shows an oscillogram of an example echo signal, consistent with some embodiments of this disclosure.

FIG. 6 shows a schematic diagram of an example structure of a receiving terminal circuit of still another LiDAR, consistent with some embodiments of this disclosure.

FIG. 7 shows a schematic diagram of an example structure of a receiving terminal circuit of yet another LiDAR, consistent with some embodiments of this disclosure.

FIG. 8 shows an oscillogram of another example echo signal, consistent with some embodiments of this disclosure.

FIG. 9 shows a flowchart of an example calibration method for a LiDAR, consistent with some embodiments of this disclosure.

FIG. 10 shows a flowchart of another example calibration method for a LiDAR, consistent with some embodiments of this disclosure.

FIG. 11 shows a schematic structural diagram of an example calibration apparatus, consistent with some embodiments of this disclosure; and

FIG. 12 shows a schematic structural diagram of an example receiving terminal circuit of a LiDAR, consistent with some embodiments of this disclosure.

### DETAILED DESCRIPTION

A single photon detector can have a high sensitivity and can detect a single photon, while ambient light can exist around a LiDAR and cause interferences in an echo signal generated by the single photon detector, so that the detection results are inaccurate.

For example, a photon detection efficiency (“PDE”) and a gain are important parameters for a single photon detector. PDE represents a probability of a single photon detector responding to a single photon, and typically refers to a ratio of the number of photons detected by the single photon detector to the number of incident photons. As an example, the PDE can represent an efficiency of converting light signals into electrical signals by the single photon detector (e.g., when 100 photons are incident onto the single photon detector, 90 photons of which are detected and converted into an electrical signal by the single photon detector, where the photon detection efficiency of the single photon detector is 90%). The higher the photon detection efficiency is, the higher a sensitivity of the single photon detector to photons is. The weaker the photon detection efficiency is, the lower the sensitivity of a silicon photomultiplier to photons is. A gain represents an increase factor of a single photon detector for converting light energy into electrical signals. A gain can be denoted by a number of charges that can be excited by a single photon. When the ambient light is strong, (e.g., in a sunlight environment with illuminance greater than 20 Klux), both the PDE and gain of the single photon detector in the LiDAR can decrease, thereby changing the response result of the single photon detector, or even further changing the detection result of the target object determined based on the output response result of the single photon detector.

In this disclosure, echo signal parameters are corrected using determined ambient light signals, to reduce or eliminate the impact of the ambient light on the echo signal. By doing so, the corrected echo signal parameters can accurately reflect the real condition of the target object and improve the accuracy of the target object detection result as well as the detection performance of the LiDAR.

Some embodiments of this disclosure are described in detail below with reference to the accompanying drawings.

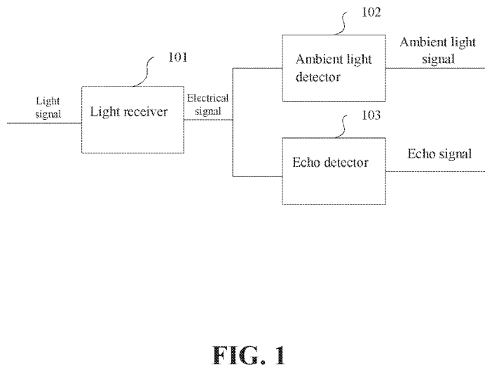

Referring to FIG. 1, FIG. 1 illustrates a schematic structural diagram of a receiving terminal circuit of a LiDAR, consistent with some embodiments of this disclosure.

In FIG. 1, the LiDAR includes a light receiver 101, an ambient-light detector 102 for detecting ambient light, and an echo detector 103 for detecting an echo from a target object. The light receiver 101 is coupled to the ambient-light detector 102 and the echo detector 103. The ambient-light detector 102 generates an ambient light signal based on an electrical signal outputted from the light receiver 101. For case of explanation, an ambient light signal in this disclosure refers to an electrical signal representing ambient light. The echo detector 103 generates an echo signal based on an electrical signal outputted from the light receiver 101. For case of explanation, an echo signal in this disclosure refers to an electrical signal representing the echo.

In some embodiments, the LiDAR can include one or more light receivers 101. For example, the light receiver can be a silicon photomultiplier (“SiPM”) or a single photon avalanche diode (“SPAD”). Multiple light receivers 101 can be arranged in a one-dimensional array (e.g., in a single column or a single row) or a two-dimensional array (e.g., area array), in particular a matrix, or can be multiple columns/rows interlaced, or the like. The light receiver 101 can receive a light signal and convert the light signal into an electrical signal.

In some embodiments, the electrical signal outputted from the light receiver 101 can include a signal caused by ambient light and a signal caused by the echo from the target object. The ambient-light detector 102 can receive an electrical signal caused by ambient light (e.g., caused by sunlight around the LiDAR or the like) from the electrical signal outputted by the light receiver 101. The echo detector 103 can receive an electrical signal caused by the echo from the electrical signal outputted from the light receiver 101.

In some embodiments, the light receiver 101 can receive a light signal and convert the light signal into an electrical signal. In some embodiments, the electrical signal can include a DC component and an AC component. For example, the DC component can correspond to the ambient light, and the AC component can correspond to the echo. In such a case, the ambient-light detector 102 can receive the DC component to generate the ambient light signal. The echo detector 103 can receive the AC component to output the echo signal.

When the LiDAR includes multiple light receivers 101, in some embodiments, each light receiver 101 can output an electrical signal to the ambient-light detector 102 and the echo detector 103. For example, each light receiver can transmit the electrical signal to the ambient-light detector 102 and the echo detector 103 based on a preset time sequence. The ambient-light detector 102 can output an ambient light signal corresponding to each of the light receiver 101 at different times based on the preset timing sequence. The echo detector 103 can output an echo signal corresponding to each of the light receiver 101 at different times based on the preset timing sequence.

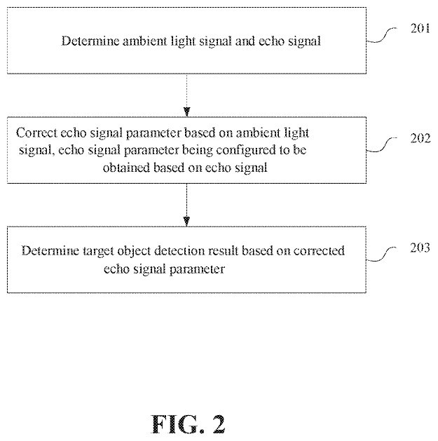

FIG. 2 shows a flowchart of a calibration method for a LiDAR, consistent with some embodiments of this disclosure.

In some embodiments, the calibration method can include the following steps.

At Step 201, an ambient light signal and an echo signal are determined.

At Step 202: an echo signal parameter is corrected based on the ambient light signal. The echo signal parameter can be determined based on the echo signal.

At Step 203: determining a target object detection result based on one or more corrected echo signal parameters.

An ambient light signal around a LiDAR can affect an echo signal from a target object of the LiDAR, thereby changing an echo signal parameter, and the echo signal parameter can affect the accuracy of the target object detection result. Consistent with some embodiments of this disclosure, an echo signal parameter can be corrected based on the ambient light signal to reduce or eliminate the impact of the ambient light on the echo signal. By doing so, the corrected echo signal parameter can reflect the real condition of the target object more accurately and improve the accuracy of the target object detection result as well as the detection performance of the LiDAR.

In some embodiments, the target object detection result can include at least one of a distance to or a reflectivity of the target object. By correcting the echo signal parameter based on the ambient light signal, at least one of a distance to or a reflectivity of the target object outputted from the LiDAR can be more accurate, and then point clouds formed by the LiDAR using at least one of a distance to or a reflectivity of the target object can be more accurate.

In some embodiments, the echo detector 103 can output a waveform based on the echo signal, and in this case, the waveform of the echo signal can be corrected based on the ambient light signal.

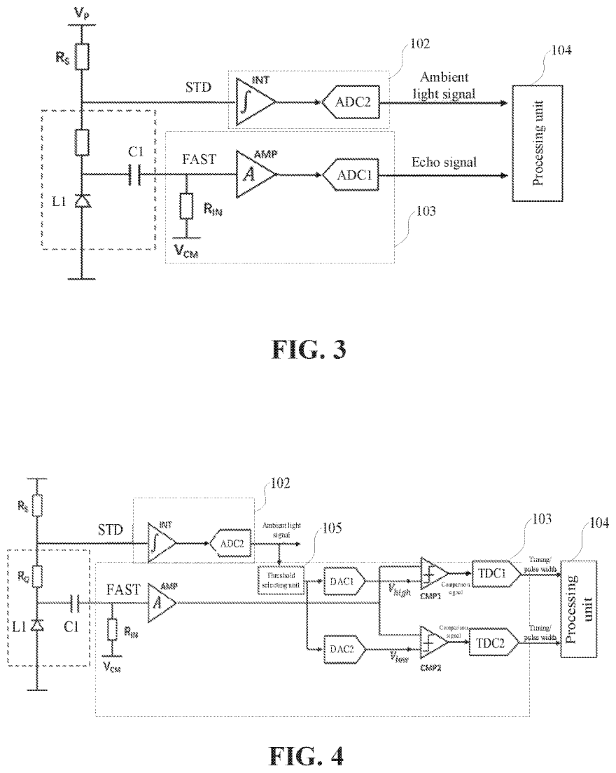

A light emitter of a LiDAR emits a pulse signal for detecting a target object. An echo is generated after the pulse signal is reflected from the target object, and the echo is received by the light receiver to generate an electrical signal. Referring to FIG. 3, FIG. 3 shows a schematic diagram of an example structure of a receiving terminal circuit of a LiDAR, consistent with some embodiments of this disclosure. A STD output terminal of a light receiver L1 outputs a DC component of an electrical signal, and a FAST output terminal of the light receiver L1 outputs an AC component of the electrical signal. A voltage difference between a high-voltage signal Vp and the voltage of the STD output terminal (cathode) of the light receiver L1 shows the signal caused by the ambient light (e.g., the voltage across a resistor Rs).

In some embodiments, the ambient-light detector 102 can include an integrator INT and an analog-to-digital converter ADC2. The light receiver L1 outputs the electrical signal. An output signal from the STD output terminal of the light receiver L1 is integrated through the integrator INT within certain time Tint with a time constant of R0×C0 to generate a voltage signal. The time constant R0×C0 is capable to adjust gain of the integrator INT. The analog-to-digital converter ADC2 samples the voltage signal outputted from the integrator INT, and converts the voltage signal into a digital signal output (e.g., a code value). The magnitude of the ambient light signal outputted from the analog-to-digital converter ADC2 can represent the ambient light intensity.

In some embodiments, the echo detector 103 can include a resistor R_{IN}, an amplifier AMP, and an analog-to-digital converter ADC1. The light receiver L1 can output the electrical signal. An output capacitor C1 can accumulate charges. The voltage of the output terminal of the output capacitor C1 can be an output signal of the FAST output terminal. The output signal can be amplified through the amplifier AMP. The analog-to-digital converter ADC1 can sample the amplified voltage signal to determine a waveform of the echo signal.

In this case, the waveform of the echo signal can be corrected based on the ambient light signal to obtain a target echo signal, and the target echo signal can obtain the target object detection result. In some embodiments, continuing to refer to FIG. 3, the LiDAR further includes a processing unit 104. The processing unit 104 can correct the waveform of the echo signal and obtain the target object detection result based on the target echo signal. For example, the processing unit 104 can include a field programmable gate array (“FPGA”), for example, the FPGA corrects the waveform of the echo signal and acquires the target object detection result based on the target echo signal.

In some embodiments, the echo detector 103 can output at least one of a peak value, a slope, and a pulse width of the echo signal. In this case, at least one of the peak value, the slope, and the pulse width of the echo signal can be corrected based on the ambient light signal.

Referring to FIG. 4, FIG. 4 shows a schematic diagram of an example structure of a receiving terminal circuit of another LiDAR, consistent with some embodiments of this disclosure. In the ambient-light detector 102, the output signal from the STD output terminal of the light receiver L1 is integrated through the integrator INT within certain time Tint with a time constant of R0×C0 to generate a voltage signal. The analog-to-digital converter ADC2 samples the voltage signal outputted from the integrator INT, and converts the voltage signal into a digital signal output, to obtain the ambient light signal.

The echo detector 103 includes a resistor Rix, an amplifier AMP, a threshold selector 105, digital-to-analog converters DACI and DAC2, comparators CMP1 and CMP2, and time-to-digital converters TDC1 and TDC2. The threshold selector 105 selects an echo detection threshold based on the ambient light signal outputted from the ambient-light detector 102 for detecting the echo signal. The echo detection threshold is selected from a high threshold and a low threshold. These thresholds are converted from digital signals to analog signals (e.g., voltage signals) by a digital-to-analog converter DAC1 and another digital-to-analog converter DAC2. The light receiver L1 outputs the electrical signal, the output capacitor C1 accumulates charges, and the voltage of the output terminal of the output capacitor C1, as the output signal of the FAST output terminal, is amplified through the amplifier AMP to output the signal representing the echo. The analog signals separately outputted from the digital-to-analog converters DAC1 and DAC2 are inputted into the comparators CMP1 and CMP2 and each of them are used as a reference value to compare with the signals representing the echo amplified by the amplifier AMP., The comparison signals are then outputted.

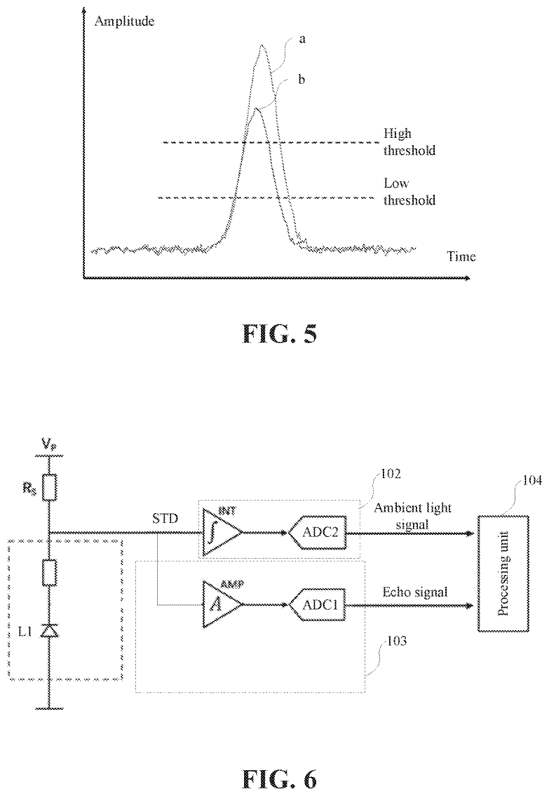

Further referring to FIG. 5, FIG. 5 shows an oscillogram of an example echo signal, consistent with some embodiments of this disclosure. Curve a represents an oscillogram of an echo signal when the ambient light is weak, and curve b represents an oscillogram of an echo signal when the ambient light is strong. It shows that, when the ambient light is strong, the echo signal is weak. In this case, a smaller low threshold can be selected for echo signal detection. When the ambient light is weak, the echo signal is strong, and in this case, a larger high threshold can be selected for echo signal detection. It thereby improvs the accuracy of echo signal detection.

Optionally, both the low threshold and the high threshold can be used for echo signal detection. The thresholds are sampled through the time-to-digital converters TDC1 and TDC2, and processed by the processing unit 104 comprehensively.

Further, after the comparison signals outputted from the comparators CMP1 and CMP2 are sampled by the time-to-digital converters TDC1 and TDC2, at least one of the peak value, the slope, and the pulse width of the echo signal is determined by the processing unit 104. For example, the slope includes a leading-edge slope configured as a slope between at least two values of the echo signal, which are obtained based on the echo detection threshold at a rising edge of the echo signal.

In some embodiments, the processing unit 104 can correct at least one of the peak value, the slope, and the pulse width of the echo signal, and determine the target object detection result based on at least one of the target peak value, the target slope, and the target pulse width.

In some embodiments, referring to FIG. 6, FIG. 6 shows a schematic diagram of an example structure of a receiving terminal circuit of still another LiDAR, consistent with some embodiments of this disclosure. Different with the LiDAR shown in FIG. 3, light receiver L1 in FIG. 6 does not have a FAST output terminal, and the ambient-light detector 102 and the echo detector 103 are jointly coupled to a STD output terminal of the light receiver L1.

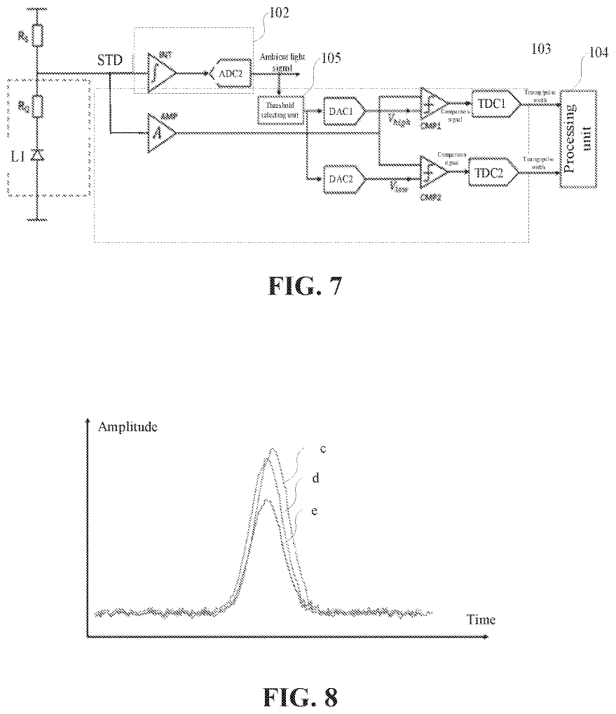

Similarly, referring to FIG. 7, FIG. 7 shows a schematic diagram of an example structure of a receiving terminal circuit of yet another LiDAR, consistent with some embodiments of this disclosure. The ambient-light detector 102 and the echo detector 103 are jointly coupled to a STD output terminal of the light receiver L1 without a FAST output terminal.

In some embodiments, it shows in FIG. 5 that, the stronger the ambient light signal is, the larger the ambient light signal affects on the echo signal and the weaker the echo signal is. Therefore, referring to a larger ambient light signal, a larger calibration value for the echo signal parameter is needed, to reduce or eliminate more impact of the ambient light on the echo signal.

In some embodiments, the light receiver is a single photon detector. When there is ambient light around the LiDAR, both the photon detection efficiency and gain of the single photon detector decrease, and the waveform of the echo signal (e.g., amplitude and shape of the echo signal) changes. The shape change is mainly caused by the variation of the photon detection efficiency of the single photon detector, and the amplitude change is mainly caused by the gain variation of the single photon detector. The amplitude of the echo signal can affect a distance to and a reflectivity of a target object detected by the LiDAR, and the shape of the echo signal can affect the reflectivity of the target object detected by the LiDAR.

In an embodiment, the distance needs to be corrected. In this case, the distance can be corrected by correcting a gain variation of the single photon detector.

In some embodiments, the calibration value includes a first calibration value. The first calibration value can be a gain variation to correct the single photon detector. For example, the first calibration value is determined based on the ambient light signal and a first calibration coefficient, while the larger the first calibration coefficient is, the larger the first calibration value is. The first calibration value is used to correct the echo signal parameter.

For example, ambient light signals with different intensities can correspond to different first calibration values. The first calibration coefficient can be preset and stored. When the echo signal needs to be corrected, the first calibration coefficient is looked up, and then the echo signal parameter is corrected based on the ambient light signal outputted from the ambient-light detector and the first calibration coefficient.

For example, the first calibration coefficient can be obtained by: determining a first test echo signal parameter when the ambient light signal is greater than a light intensity threshold, and a standard echo signal parameter corresponding to the ambient light signal; and obtaining the first calibration coefficient by fitting the ambient light signal, the first test echo signal parameter, and the standard echo signal parameter.

In some embodiments, the first calibration coefficient can be obtained, after adjusting and obtaining different ambient light signals, determining the corresponding first test echo signal parameter and the standard echo signal parameter, by fitting the ambient light signal, the first test echo signal parameter, and the standard echo signal parameter.

It should be noted that the value of the first calibration coefficient can correspond to the model of the light receiver, for example, different models of light receivers correspond to different first calibration coefficients. A corresponding relationship between the model of the light receiver and the first calibration coefficient can be preset, which is not limited in this disclosure.

For example, further referring to FIG. 8, curve c represents a waveform of an echo signal under normal ambient light, and curve e represents a waveform of an echo signal under strong ambient light. Compared with the curve c, the amplitude of the echo signal shown in the curve e is obviously reduced. As described above, the amplitude variation of the echo signal is mainly caused by the gain variation of the single photon detector. Therefore, the impact of the ambient light on the gain of the single photon detector can be corrected using the first calibration value, so that the amplitude of the echo signal reaches the amplitude of the echo signal under the normal ambient light. The waveform of the echo signal corrected using the first calibration value is as shown in the curve d.

Further, the distance to the target object is determined based on the echo signal parameter corrected using the first calibration value, so that the detected distance to the target object is more accurate. For example, leading-edge time is obtained at a rising edge of the corrected echo signal based on the echo detection threshold, and a calibration value for the leading-edge time is obtained based on a peak value of the corrected echo signal. The determined leading-edge time and the determined calibration value are used to correct the leading-edge time and determine the distance to the target object.

In another embodiment, the reflectivity needs to be corrected. In this case, the gain variation amount of the single photon detector and the variation amount of the photon detection efficiency of the single photon detector need to be corrected.

In some embodiments, the gain variation amount of the single photon detector can be corrected based on the first calibration value, and the variation amount of the photon detection efficiency of the single photon detector can be corrected using a second calibration value.

In some embodiments, the second calibration value is determined based on the ambient light signal and a second calibration coefficient, where the larger the second calibration coefficient is, the larger the second calibration value is; and the echo signal parameter is corrected using the second calibration value.

For example, ambient light signals with different intensities can correspond to different second calibration values. The second calibration coefficient can be preset and then stored. When the echo signal needs to be corrected, the second calibration coefficient is looked up, and then the echo signal parameter is corrected using the ambient light signal and the second calibration coefficient.

Further, the second calibration coefficient can be obtained by: determining a second test echo signal parameter when the ambient light signal is less than a light intensity threshold, and the standard echo signal parameter corresponding to the ambient light signal; and obtaining the second calibration coefficient by fitting the ambient light signal, the second test echo signal parameter, and the standard echo signal parameter.

In some embodiments, different second calibration coefficients can be obtained by fitting ambient light signals with different intensities. For example, different ambient light signals can be obtained, and the corresponding second test echo signal parameter and the standard echo signal parameter can be determined.

The first test echo signal parameter, the second test echo signal parameter, and the standard echo signal parameter of the light receiver of the LiDAR are obtained by testing under different ambient light intensities, to obtain the first calibration coefficient and the second calibration coefficient by fitting.

Further, the reflectivity of the target object is determined based on the echo signal parameter corrected using the first calibration and the second calibration, so that the detected reflectivity of the target object is more accurate.

For example, leading-edge time is obtained at a rising edge of the corrected echo signal based on the echo detection threshold, a calibration value for the leading-edge time is obtained based on a peak value of the corrected echo signal, and the obtained leading-edge time and the obtained calibration value can correct the leading-edge time and determine the distance to the target object. Regarding the reflectivity of the target object, based on the above distance and a peak value of the corrected echo signal, a first reflectivity corresponding to the peak value at the above distance is obtained, and then the first reflectivity is further corrected using the second calibration value to obtain a second reflectivity of the target object.

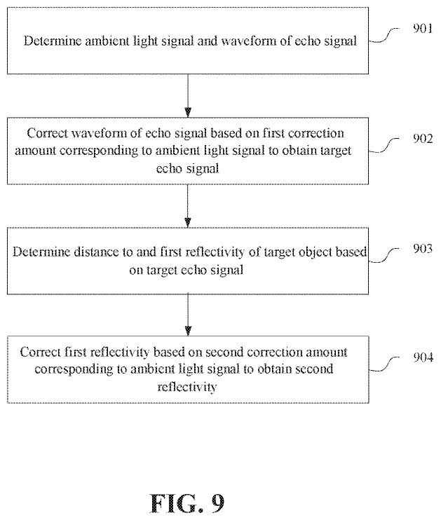

In some embodiments, referring to FIG. 9, FIG. 9 shows a flowchart of an example calibration method for a LiDAR, consistent with some embodiments of this disclosure.

At Step 901: determining an ambient light signal and a waveform of an echo signal.

For example, the ambient light signal and the waveform of the echo signal can be determined using the LiDAR with the structure shown in FIG. 3 or 7.

At Step 902: correcting the waveform of the echo signal based on a first calibration value corresponding to the ambient light signal to obtain a target echo signal.

At Step 903: determining a distance to and a first reflectivity of a target object based on the target echo signal.

For example, an echo signal parameter, such as a peak value, a slope, and a pulse width of the echo signal, is determined using the target echo signal, and then the distance to and the first reflectivity of the target object are determined using the above parameters. For example, leading-edge time is obtained at a rising edge of the corrected echo signal based on the echo detection threshold, a calibration value for the leading-edge time is obtained based on a peak value of the corrected echo signal, and the obtained leading-edge time and the obtained calibration value can correct the leading-edge time and determine the distance to the target object. Regarding the reflectivity of the target object, based on the above distance and the peak value of the corrected echo signal, the first reflectivity corresponding to the peak value at the above distance is obtained.

At Step 904: correcting the first reflectivity based on a second calibration value corresponding to the ambient light signal to obtain a second reflectivity.

In some embodiments, a light receiver needs to perform steps 901 to 904 during each ranging. In some embodiments of the step 902, correcting the waveform of the echo signal refers to correcting a signal outputted from an analog-to-digital converter.

In some embodiments, the target object detection result includes the distance determined in the step 903 and the second reflectivity determined in the step 904.

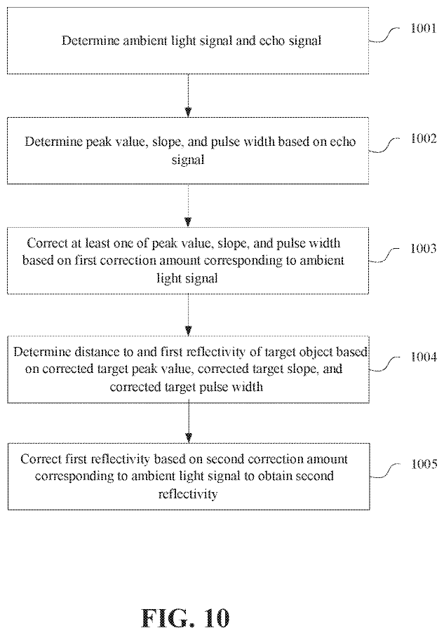

In some embodiments, referring to FIG. 10, FIG. 10 shows a flowchart of another example calibration method for a LiDAR, consistent with some embodiments of this disclosure.

At Step 1001: determining an ambient light signal and an echo signal.

For example, the ambient light signal and the echo signal can be determined using the LiDAR with the structure shown in FIG. 4 or 7.

At Step 1002: determining a peak value, a slope, and a pulse width based on the echo signal.

At Step 1003: correcting at least one of the peak value, the slope, and the pulse width based on a first calibration value corresponding to the ambient light signal.

At Step 1004: determining a distance to and a first reflectivity of a target object based on the corrected target peak value, the corrected target slope, and the corrected target pulse width.

At Step 1005: correcting the first reflectivity based on a second calibration value corresponding to the ambient light signal, to obtain a second reflectivity.

In some embodiments, the target object detection result includes the distance determined in the step 1004 and the second reflectivity determined in the step 1005.

In the embodiment of this disclosure, the correction is made for at least one of the peak value, the slope, and the pulse width, rather than the entire echo signal (i.e., a waveform of the echo signal), thereby reducing the computation workload and improving the computation efficiency and the detection efficiency.

The working mode or the principle of the calibration method refers to FIGS. 1 to 8 and corresponding embodiments thereof, and is not repeated herein.

The calibration method described above can be executed by the LiDAR, for example, the steps described above can be executed using a processor inside the LiDAR, or can be executed using a terminal device connected to the LiDAR.

It should be noted that the sequence number of each step in some embodiments does not limit the execution sequence of each step.

It can be understood that, in some embodiments, the calibration method can be implemented in the form of a software program. The software program runs in a processor integrated within a chip or a chip module. This method can also be implemented using software in combination with hardware, which is not limited in this disclosure.

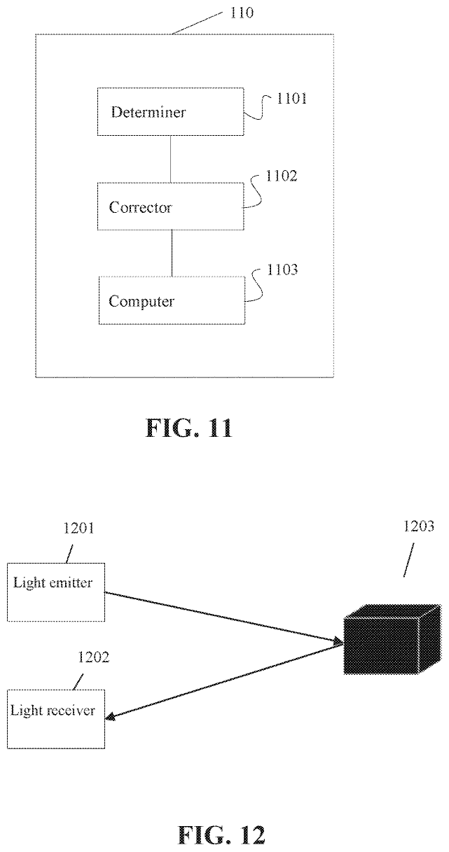

Referring to FIG. 11, FIG. 11 shows a schematic structural diagram of an example calibration apparatus, consistent with some embodiments of this disclosure The calibration apparatus 110 can include:
a determiner 1101 for determining an ambient light signal and an echo signal;
a corrector 1102 for correcting an echo signal parameter based on the ambient light signal, the echo signal parameter can be obtained based on the echo signal or a waveform of the echo signal; and
a computer 1103 for determining a target object detection result based on the corrected echo signal parameter.

In some embodiments, the echo signal parameter is corrected using the determined ambient light signal, to reduce or eliminate the impact of ambient light on the echo signal, so that the corrected echo signal parameter can accurately reflect real condition of a target object, thereby improving the accuracy of the target object detection result, and the detection performance of the LiDAR.

In some embodiments, the corrector 1102 includes a first correcting unit for correcting a waveform of the echo signal based on the ambient light signal to obtain a target echo signal. The target echo signal can obtain the target object detection result.

In some embodiments, the corrector 1102 includes a second correcting unit for correcting at least one of a peak value, a slope, and a pulse width to obtain at least one of a target peak value, a target slope, and a target pulse width. At least one of the target peak value, the target slope, and the target pulse width can obtain the target object detection result.

It should be noted that whether the corrector 1102 includes the first correcting unit or the second correcting unit can be determined based on a specific structure of the LiDAR. For example, in the LiDAR shown in FIG. 3 or 6, the corrector 1102 includes the first correcting unit; and in the LiDAR shown in FIG. 4 or 7, the corrector 1102 includes the second correcting unit.

The working mode or the principle of the calibration apparatus 110 refers to FIGS. 1 to 10 and corresponding embodiments thereof, and is not repeated herein.

In some embodiments, the calibration apparatus described above can correspond to a chip with a calibration function in a LiDAR or terminal device, such as a System-On-a-Chip (“SOC”), a baseband chip, or the like; or can correspond to a chip module with a calibration function included in a LiDAR or terminal device; or can correspond to a chip module having a chip with a data processing function, or can correspond to a LiDAR or terminal device.

An embodiment of this disclosure further discloses a LiDAR. Referring to FIG. 12, FIG. 12 shows a schematic structural diagram of an example receiving terminal circuit of a LIDAR, consistent with some embodiments of this disclosure. The LiDAR includes at least one light emitter 1201 and at least one light receiver 1202. The LiDAR emits a detection pulse signal through the light emitter 1201. The light receiver 1202 receives a light signal and generates an output signal. The light signal includes ambient light and an echo of the detection pulse signal reflected from a target object 1203.

Further, the at least one light receiver 1202 is arranged corresponding to at least one light emitter 1201.

In some embodiments, the LiDAR can further include a receiving terminal circuit of the LiDAR shown in FIG. 1, 3, 4, 6, or 7. For example, the LiDAR can include an ambient-light detector that generates an ambient light signal based on the output signal from the light receiver 1202; and an echo detector that generates an echo signal based on the output signal from the light receiver 1202.

The implementation of the ambient-light detector and the echo detector refers to the above embodiments and is not repeated herein.

Further, the light emitter 1201 can be an edge emitting laser (“EEL”), a vertical cavity surface emitting laser (“VCSEL”), or any other implementable luminotron. The light receiver 1202 can be a single photon detector, including a silicon photomultiplier (“SiPM”), a single photon avalanche diode (“SPAD”) array, or the like.

Further, the light emitter 1201 emits a detection pulse signal within a target detection period. The light receiver 1202 receives the light signal and generates the output signal. The ambient-light detector and the echo detector determine the ambient light signal and the echo signal based on the output signal. In some embodiments, the echo signal is calibrated by the ambient light signal during a normal detection of the LiDAR, thereby ensuring the accuracy of a distance to and/or a reflectivity of the target object detected by the LiDAR.

In an embodiment, within the target detection period, the light emitter 1201 emits a detection pulse signal, and the light receiver 1202 receives the light signal and generates an output signal. The echo detector first determines the ambient light signal based on the output signal, then determines the echo signal based on the output signal, and then calibrates the echo signal using the ambient light signal. By first detecting the ambient light signal and then detecting the echo signal, the interference of the echo signal with the ambient light signal can be decreased or avoided, so that the ambient light signal is more accurately measured, thus ensuring more accurate calibration of the echo signal, and further improving the accuracy of the target object detection result.

The modules/units included in the apparatuses and products described in the disclosure can be software components, or can be hardware components, or can be partially software components and partially hardware components. For example, the modules/units included in the apparatuses and products applied to or integrated into a chip can be implemented in the form of hardware such as circuits, or at least part of the modules/units can be implemented in the form of a computer program running in a processor integrated inside the chip, and the remaining (if any) part of the modules/units can be implemented in the form of hardware such as circuits. The modules/units included in the apparatuses and products applied to or integrated into a chip module can all be implemented in the form of hardware such as circuits, different modules/units can be located in a same component (e.g., a chip, a circuit module, or the like) or in different components within the chip module, or at least a part of the modules/units can be implemented in the form of a software program running in a processor integrated inside the chip module, and the remaining (if any) part of the modules/units can be implemented in the form of hardware such as circuits. The modules/units included in the apparatuses and products applied to or integrated into a terminal can all be implemented in the form of hardware such as circuits, different modules/units can be located in a same component (e.g., a chip, a circuit module, or the like) or in different components within the terminal, or at least a part of the modules/units can be implemented in the form of a software program running in a processor integrated inside the terminal, and the remaining (if any) part of the modules/units can be implemented in the form of hardware such as circuits.

In some embodiments, it further discloses a storage medium. The storage medium is a computer-readable storage medium storing a computer program thereon. The computer program, when running, can execute steps of the above-mentioned method. The storage medium can include a read-only memory (“ROM”), a random access memory (“RAM”), a magnetic disk, optical disk, or the like. The storage medium can further include a non-volatile memory, a non-transitory memory, or the like.
The terms “or” and “and/or” of this disclosure describe an association relationship between associated objects, and represent a non-exclusive inclusion. For example, each of “A and/or B” and “A or B” can include: only “A” exists, only “B” exists, and “A” and “B” both exist, where “A” and “B” can be singular or plural. For another example, each of “A, B, and/or C” and “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In addition, the symbol “/” herein represents that the associated objects before and after the character are in an “or” relationship. In this disclosure, the term “at least one of A or B” has a meaning equivalent to “A or B” as described above. The term “at least one of A, B, or C” has a meaning equivalent to “A, B, or C” as described above.

In addition, the character “/” herein indicates that there is an “or” relationship between associated objects therebefore and thereafter.

The term “plurality of” appearing in the embodiments of this disclosure refers to two or more.

Descriptions such as “first” and “second” appearing in the embodiments of this disclosure are merely for the purpose of schematic illustration and distinguishing the described objects, and are in no order, nor do they indicate a particular limitation on the number of devices in the embodiments of this disclosure, and cannot form any limitation on the embodiments of this disclosure.

The term “connection” appearing in the embodiments of this disclosure refers to various connection manners such as a direct connection or an indirect connection to realize the communication between devices, which is not limited in any way in the embodiments of this disclosure.

It should be understood that in the embodiments of this disclosure, the processor can be a central processor (simply referred to as “CPU”), or can be other general-purpose processors, a digital signal processor (simply referred to as “DSP”), an application specific integrated circuit (simply referred to as “ASIC”), a field programmable gate array (simply referred to as “FPGA”) or other programmable logic devices, a discrete gate or transistor logic device, a discrete hardware component, or the like. The general-purpose processor can be a microprocessor or the processor can also be any conventional processor, or the like.

It should be further understood that the memory in the embodiments of this disclosure can be a volatile memory or a non-volatile memory, or can include both a volatile memory and a non-volatile memory. The non-volatile memory can be a read-only memory (simply referred to as “ROM”), a programmable read-only memory (programmable ROM, simply referred to as “PROM”), an erasable programmable read-only memory (erasable PROM, simply referred to as “EPROM”), an electrically erasable programmable read-only memory (electrically EPROM, simply referred to as “EEPROM”), or a flash memory. The volatile memory can be a random access memory (simply referred to as “RAM”), which is used as an external cache. By way of an example illustration, but not a limiting illustration, many forms of random access memory (simply referred to as “RAM”) are available, such as a static random access memory (static RAM, simply referred to as “SRAM”), a dynamic random access memory (simply referred to as “DRAM”), a synchronous dynamic random access memory (synchronous DRAM, simply referred to as “SDRAM”), a double data rate synchronous dynamic random access memory (double data rate SDRAM, simply referred to as “DDR SDRAM”), an enhanced synchronous dynamic random access memory (enhanced SDRAM, simply referred to as “ESDRAM”), a synchlink dynamic random access memory (synchlink DRAM, simply referred to as “SLDRAM”), and a direct rambus random access memory (direct rambus RAM, simply referred to as “DR RAM”).

The above embodiments can be implemented completely or partially by software, hardware, firmware, or any combination thereof. When implemented by software, the above embodiments can be implemented completely or partially in the form of a computer program product. The computer program product includes one or more computer instructions or computer programs. When the computer instructions or computer programs are loaded or executed on a computer, the processes or functions described in the embodiments of this disclosure are generated completely or partially. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instructions can be transmitted from a website, computer, server, or data center to another website, computer, server, or data center wiredly or wirelessly. The computer-readable storage medium can be any available medium accessible to the computer, or can be a data storage device containing a collection of one or more available mediums, such as a server, a data center, or the like. It should be understood that in the embodiments of this disclosure, the magnitudes of the sequence numbers of the above-mentioned processes do not mean the execution sequence. The execution sequence of the processes should be determined based on functions and internal logics thereof, and should not impose any limitation on the implementation of the embodiments of this disclosure.

It should be understood that the method, apparatus, and system disclosed in the embodiments provided in this disclosure can be implemented in other ways. For example, the apparatus embodiments described above are merely illustrative. For example, the division of the units is only a logical function division and there can be other manners of division during actual implementations. For example, a plurality of units or components can be combined or can be integrated into another system, or some features can be omitted or cannot be performed. In addition, the illustrated or discussed coupling or direct coupling or communicative connection between each other can be indirect coupling or communicative connection among apparatuses or units via some interfaces, and can be electrical connection, mechanical connection, or other forms of connection.

The units described as separate components can or cannot be physically separated, the components illustrated as units can or can not be physical units, for example, they can be in the same place or can be distributed to a plurality of network units. A part or all of the units can be selected based on actual requirements to achieve the purpose of the solutions of some embodiments.

In addition, the functional units in the embodiments of this disclosure can be integrated into one processor, or each unit can be physically included alone, or two or more units can be integrated into one unit. The above integrated unit can be implemented in the form of hardware, or can be implemented in the form of hardware in combination with software functional units.

The above-mentioned integrated unit implemented in the form of the software functional units can be stored in a computer-readable storage medium. The above-mentioned software functional units are stored in a storage medium, and include some instructions for causing a computer device (which can be a personal computer, a server, a network device, or the like) to perform some steps of the methods described in the embodiments of this disclosure.

Although this disclosure is disclosed as above, it is not limited thereto. Any person skilled in the art can make various alterations and modifications without departing from the spirit and scope of this disclosure. Therefore, the protection scope of this disclosure should be subject to the scope defined by the claims.

1.-23. (canceled).

24. A LiDAR, comprising:
a light emitter configured to emit a detection pulse signal for detecting an object,
a light receiver configured to receive an ambient light and generate a first output signal, and to receive an echo and generate a second output signal,
an ambient-light detecting circuit configured to generate an ambient light signal based on the first output signal from the light receiver,
an echo detecting circuit configured to generate an echo signal based on the second output signal from the light receiver, and
a processor coupled to the ambient-light detecting circuit and the echo detecting circuit, and the processor is configured to determine a distance to an object based on the ambient light signal and the echo signal.

25. The LiDAR of claim 24, wherein the ambient-light detector and the echo detecting circuit are coupled to a same output terminal of the light receiver.

26. The LiDAR of claim 24, wherein the ambient-light detector comprises:
an integrator configured to integrate the first output signal generated by the light receiver in response to receiving the ambient light, and
a first analog-to-digital converter configured to sample an output signal from the integrator to obtain the ambient light signal.

27. The LiDAR of claim 24, wherein the echo detecting circuit comprises:
an amplifier configured to amplify the second output signal generated by the light receiver in response to receiving the echo, and
a second analog-to-digital converter configured to sample an amplified signal from the amplifier.

28. The LiDAR of claim 24 wherein the echo detecting circuit comprises:
an amplifier configured to amplify the second output signal generated by the light receiver in response to receiving the echo,
a first comparator configured to compare an amplified signal with a first threshold and output a first comparison result,
a first time-to-digital converter configured to sample the first comparison result,
a second comparator configured to compare the amplified signal with a second threshold and output a second comparison result, and
a second time-to-digital converter configured to sample the second comparison result.

29. The LiDAR of claim 28, further comprising a threshold selector coupled to the ambient-light detecting circuit and the echo detecting circuit, the threshold selector is configured to select either the first threshold or the second threshold based on the ambient light signal, and a selected threshold is configured to be used to determine the distance to an object.

30. The LiDAR of claim 29, wherein the processor is further configured to determine an echo signal parameter based on sampled first comparison result and sampled second comparison result.

31. The LiDAR of claim 24, wherein the light receiver comprises a single photon detector.

32. The LiDAR of claim 31, wherein the processor is further configured to correct the echo signal based on the ambient light signal, and determine the distance to the object based on a corrected echo signal.

33. The LiDAR of claim 32, wherein the processor is further configured to:
correct an echo signal parameter by a first calibration value to determine a first corrected echo signal parameter, the echo signal parameter being configured to be determined based on the echo signal, and
determine the distance to the object based on the first corrected echo signal parameter, and wherein the echo signal parameter comprises at least one of a waveform, a peak value, a slope, and a pulse width of the echo signal.

34. The LiDAR of claim 33, wherein the first calibration value is relative to a gain of the single photon detector.

35. The LiDAR of claim 34, wherein the processor is further configured to:
correct the first corrected echo signal parameter by a second calibration value to determine a second corrected echo signal parameter, and
determine a reflectivity of the object based on the second corrected echo signal parameter.

36. The LiDAR of claim 35, wherein the second calibration value is relative to a photon detection efficiency of the single photon detector.
